(19) United States
(12) Patent Application Publication
(10) Pub. No.: US 2016/0138314 A1
(43) Pub. Date: May 19, 2016

(54) ROLLER CARRIAGE FOR THE RECEPTION OF A SLIDING DOOR WITH AN ACCESSORY DEVICE

(71) Applicant: DORMA Deutschland GmbH, Ennepetal (DE)

(72) Inventors: Ralf KREYENBORG, Ennepetal (DE); Arne LIEBSCHER, Ennepetal (DE); Sandra KLEMENS, Ennepetal (DE); Marc-Andre SCHNEIDER, Ennepetal (DE); Ralf HOHER, Ennepetal (DE)

(21) Appl. No.: 14/938,778

(22) Filed: Nov. 11, 2015

(30) Foreign Application Priority Data
Nov. 14, 2014 (EP) 14193360.6

(51) Int. Cl. E05D 15/06; E05F 7/00; F16C 29/10; F16C 29/12; F16C 41/00; F16C 29/04; E05F 7/04; F16C 29/00

(52) U.S. Cl. CPC E05D 15/0647; E05F 7/04; E05F 7/005; E05D 15/0652; E05D 15/0643; F16C 29/005; F16C 29/12; F16C 41/00; F16C 29/04; F16C 29/10

(57) ABSTRACT

The invention relates to a roller carriage for the reception of a sliding door including a roller module for the displaceable affixing to a roller running path, and a basic body for the attachment to the sliding door, wherein the roller carriage, for the attachment of a first accessory module of at least two different accessory modules, includes at least one accessory device with a locating surface for contacting a counter-locating surface of the first accessory module, and at least one accessory attachment means for the attachment of the first accessory module.

### FIELD

The present disclosure relates to a roller carriage for the reception of a sliding door with an accessory device, an accessory module for the attachment to an accessory device of such a roller carriage, a sliding door installation with a corresponding roller carriage, as well as to a method for the attachment of an accessory module according to the present disclosure.

### BACKGROUND

Basically, it is known that roller carriages are employed for allowing to guarantee the function of sliding doors. Usually, such roller carriages include a roller module, which can be inserted into a roller running path to be displaceable. Such a roller running path is usually attached to the wall or the ceiling above the door opening. Furthermore, such a roller carriage is usually equipped with an attachment option for the sliding door. Usually, such roller carriages are specific for the respective application purpose. Sliding door installations may have the most different technical functions. In addition to a basic function, namely opening and closing the sliding door by means of a corresponding sliding movement, a plurality of additional functions is possible. In the prior art sliding door installations, the roller carriages are in this case adapted specifically to the respective additional function, respectively to the respective number of additional functions. Said additional functions may include for example automatic drive devices for performing the sliding movement. Also, abutment devices for dampening the opening procedure or the closing procedure are conceivable. Also safety devices, which prevent unwanted closing, may be a part of such additional functions. Last but not least, a locking possibility may form such an additional function.

In the prior art systems, it is disadvantageous that the roller carriages need to be specifically adapted to the respective additional function, respectively to the respective number of additional functions. In other words, each combination of additional functions requires a separate roller carriage. In addition usually, the number of required different roller carriages is even doubled for an affixing on the left side or on the right side with a corresponding sliding door. This huge number of different roller carriages results in an overall high complexity, which in turn translates into high manufacturing cost and high prices for the individual roller carriages. Moreover, the flexibility of application for such a specifically configured roller carriage is considerably reduced.

Therefore, the present disclosure provides a roller carriage to reduce the complexity of such a system, and to increase the application flexibility of individual roller carriages.

### SUMMARY

Features and details, described in conjunction with the inventive roller carriage are obviously also valid in conjunction with the inventive accessory module, with the inventive sliding door installation as well as with the inventive method, and respectively vice versa, such that mutual reference is made, respectively can be made with respect to the disclosure of individual aspects of the invention.

An inventive roller carriage serves for accommodating a sliding door. For this purpose, the roller carriage includes a roller module for a displaceable affixing at a roller running path. Furthermore, a basic body is provided for an attachment to the sliding door. An inventive roller carriage is distinguished in that said roller carriage includes at least one accessory device for the attachment of a first accessory module of at least two different accessory modules. Said accessory device is equipped with a locating surface for contacting a counter-locating surface of the first accessory module. Moreover, at least one accessory attachment means is provided for the attachment of the first accessory module.

An inventive roller carriage includes in particular at least two structural components, namely the roller module and the basic body. In this case, obviously further structural components may be provided and/or said two structural components may be composed of individual bodies. A roller carriage according to the idea of the present disclosure is an overall system, which fulfills at least two functions. On the one hand, the roller module allows for the displaceable affixing on the roller running path. Even if, already in this stage, the terminology of rollers is utilized, an affixing of bearing devices for rollers represents only one optional embodiment of an inventive roller carriage. Obviously for the displaceable bearing, such a roller carriage may likewise include a linear guidance, for example an anti-friction bearing or a linear drive. However, with regard to reduced complexity and reduced cost, the embodiment with rotatable rollers is preferred for such a bearing device. The second function relates to the attachment of the sliding door. In this case, the attachment may be a clamped attachment.

According to the disclosure, the roller module and the basic body are separate structural components, respectively separate bodies. Each one of said two structural components, namely the roller module and/or the basic body, may in turn include a plurality of individual components, which are connected among each other. Thus, the roller module may include for example corresponding bearing devices in the shape of rotatably supported rollers. The basic body may include a plurality of individual structural components, such as for example further devices for the additional functions. In addition to a height adjusting device, they may as well include a securing device, a fixing device or else a clamping device, by means of which the sliding door can be attached to the basic body.

Basically and according to the disclosure, the direction of movement by means of the roller carriage is freely selectable. Thus, in this case within the scope of the present disclosure, a movement along a straight can be performed, just as well as a movement along a line of movement, which is curved or curved several times, is conceivable.

In this case, a displaceable affixing to a roller running path is to be understood specifically for the respective embodiment of the bearing. In case bearing devices in the shape of individual rollers are provided, said rollers are inserted into a corresponding roller running path. If, for example, an anti-friction bearing is provided, affixing the roller module is realized on a corresponding sliding rail, respectively at a corresponding sliding rail.

Preferably, the roller module is manufactured from steel casting material. The basic body may be lighter and manufactured for example from light metal diecast. As light metal diecast, in particular aluminum or zinc are utilized.

According to the disclosure, just a single roller carriage is provided, which can be likewise referred to as basic roller carriage. Such a basic roller carriage may be specified now by means of corresponding accessory modules and thereby specifically retrofitted or upgraded for one or more additional functions by means of appropriate accessory module. The terminology of an accessory module according to the idea of the present disclosure is understood as a technical apparatus, which is able to fulfill, at least partially, at least one or more functions for the roller carriage. If, for example, a locking function in one of the terminal positions of the roller carriage is desired, such an accessory module may include a corresponding bolt portion, which, in a locking position, can stationarily latch at a terminal position of the sliding door. Accordingly, other functional portions of the accessory module can be provided for other functions. According to the disclosure, the roller carriage now includes the basic functions, which can be basically provided for all application situations. These are understood to include in particular the displaceable affixing at the roller running path as well as the attachment of the sliding door. The affixing on the roller running path allows for the displaceable movement of the roller module and thereby of the roller carriage along said roller running path. The attachment of the sliding door allows for attaching the sliding door for said movement, in order to be able to move the roller carriage together with the sliding door with regard to an opening movement and a closing movement.

In the event now one or more additional functions are desired, the person realizing the mounting process at the installation site has several accessory modules available. In this case, the different accessory modules are in particular each specifically directed to exactly one or more additional functions. In the event a defined specific additional function is desired, the associated correlating specific accessory module is selected as the first accessory module. With the inventive configuration of an accessory device, the latter is so to say configured as a universal accessory interface. By said universal configuration of the accessory device, which is in particular expressed by the universal correlation and configuration of the locating surface as well as the accessory attachment means, basically it is now possible to attach two or more different accessory modules to the accessory device. Obviously, in an accessory device in particular only a single accessory module can be attached at the same time. However, which of the different accessory modules is to be attached as said first accessory module, can be freely selected.

As can be seen from the above explanation, the flexibility for a basic configuration of an inventive roller carriage is significantly increased. In particular all accessory functions can be offered as an upgrade of said roller carriage by correspondingly attaching the corresponding specific accessory module to the accessory device. In this case, a single universal roller carriage may be provided, which, at reduced complexity, is able to fulfill any number of different additional functions. In this case, it may be advantageous, if one or more accessory devices are provided such that even two or more accessory modules can be attached in parallel and thereby simultaneously to the roller carriage. While for different combinations of additional functions according to the state-of-the-art, different specific roller carriages were required, now a universal roller carriage can be upgraded by means of corresponding specific additional modules. The complexity of different additional functions is thereby reduced to specific accessory modules, which, based on their dimensions and complexity, can be manufactured at considerably reduced effort and cost. Another decisive advantage is found in that the basic configuration and the universal interface function of the accessory device allow for combining such a roller carriage essentially optional with different accessory modules, such as to, even based on the specific accessory modules, the complexity with regard to the optional choice of combination of different additional functions in a roller carriage is considerably reduced.

Furthermore, it is conceivable that the locating surfaces according to the present disclosure can be configured to be completely bare. Thus, the locating surface and the counter-locating surface may present flat or at least partially flat extensions. Also, differently oriented flat portions of the locating surface and of the counter-locating surface are conceivable according to the idea of the present disclosure. Also, completely bare formed locating surfaces or counter-locating surfaces can be employed, as well as curved configurations of said surfaces. This circumstance allows for example for generating an at least partial positive connection, as will be explained in the following.

Accessory attachment means are understood as structural components, which serve for the attaching disposition of the accessory module. For this purpose reversible or irreversible acting accessory attachment means may be employed. For example threaded holes with a corresponding threaded bolt can be employed as accessory attachment means. Also irreversible solutions, such as riveting or at least partial bonding are possible as accessory attachment means according to the idea of the present disclosure.

It may be advantageous, if, in an inventive roller carriage, the accessory device is configured as a part of the basic body, in particular the surface of the basic body includes the locating surface in one section. This results in a further reduction of the complexity. In particular, if the roller carriage is equipped with a height adjusting device, the correlation of the accessory device with the basic body may entrain advantages. Automatically with a height adjustment of the basic body and thereby also of the sliding door, simultaneously the accessory module is fine-tuned to the same height. In correlation with stationary structural components separate from the roller carriage, which are intended to cooperate with the accessory module, this arrangement automatically results in a parallel fine-tuning possibility for said accessory modules. The complexity and seize of the roller module, respectively of the basic body and thus of the entire roller carriage are likewise reduced thereby. In this case, the basic body may obviously include several structural components or may be provided integrally and thereby in a monolithic way with the corresponding locating surface.

It is likewise advantageous, if, in an inventive roller carriage, the roller carriage includes at least two accessory devices, which are disposed symmetrically or essentially symmetrically with regard to each other. A symmetric disposition allows now for employing the same universal roller carriage both on the left side and on the right side. Thus, the accessory module can be freely selected according to the mounting position, independently of the roller carriage being intended for a left side disposition or a right side disposition. Said symmetric configuration of at least two accessory modules reduces the number of universal roller carriages again in half, because the same roller carriage is basically employable for a left side and right side disposition. The specification with regard to a left side or a right side affixing of the roller carriage is realized by means of the corresponding selection of one of the two accessory devices for the corresponding mounting of the respective accessory module. In addition to the reduction of the complexity, this translates into an increase in the possible lot size of such universal roller carriages, and thereby to a reduction of the cost per piece. The above-described symmetry refers in this case in particular to a plane, in which the sliding direction of the roller carriage is vertical or essentially vertical.

It is furthermore advantageous, if, in an inventive roller carriage, said roller carriage includes at least two accessory devices, the accessory attachment means thereof being disposed in an identical or in an essentially identical raster. Said accessory attachment means are conceivable for example in the form of holes, bolts, screws or threaded pins. As often two or more accessory attachment means are necessary per each attachment device, a raster can be formed, which is preferably configured to be identical for two, in particular for all accessory devices. This results in that the respective specifically selected first accessory module can be freely mounted at each of said accessory devices. Moreover, such a raster may include the function of specifying the orientation of the accessory module. The mounting effort and the uncertainty with regard to the mounting orientation are thereby considerably reduced. Moreover, the complexity of the overall system is thereby even further reduced. The raster configuration, in particular with regard to mounting axes of corresponding holes, bolts or threaded screws, is in particular parallel or essentially parallel to the axes of rotation of rollers of a bearing device of the roller module. The individual axes, axes of rotation, axes of motion or translatory axes, of the accessory attachment means are in this case preferably all or essentially all parallel with regard to each other. This provision results again in a reduction of the associated mounting complexity.

Furthermore, it is advantageous, if, in an inventive roller carriage, said roller carriage includes at least two accessory devices, the accessory attachment means thereof including an identical or an essentially identical attachment function. By attachment function is understood in particular a differentiation between positive connection, friction connection and/or non-positive connection. In this case, likewise a combination of two or more different attachment functions can be provided. In case all accessory attachment means of all accessory devices are essentially configured to be identical with regard to their attachment function, this provision reduces again the mounting complexity as well as the corresponding mounting effort. For example, when configuring the accessory attachment means with threads, all threads can be configured with the same thread direction and the same thread pitch. In case the accessory attachment means include manipulation interfaces, preferably all accessory attachment means are equipped with the identical or essentially identical manipulation interfaces. This means one and the same mounting tool can be employed for all accessory devices.

It is likewise advantageous, if, in an inventive roller carriage, the accessory attachment means include oblong holes, the extension thereof being configured in particular along a direction of gravity. A direction of gravity relates in this case to the mounting situation of the roller carriage and is directed from the top to the bottom and to the floor below the roller carriage. Such oblong holes allow, in particular in cooperation with corresponding threaded screws or threaded bolts, for a height adjustment of the accessory module. In contrast, respectively in addition to a basically provided height adjusting device of a basic body, respectively of a roller module, in this case an additional relative displacement of the disposed accessory module with regard to the roller module and/or to the basic body can be realized. This arrangement of transversely extending oblong holes, of oblong holes extending in the direction of gravity or of oblique holes, respectively holes arranged in a crossed shape, allows for providing an increased flexibility with regard to the orientation of the accessory module.

It is furthermore advantageous, if, in an inventive roller carriage, the locating surface, at least partially, is configured for a positive connection with the counter-locating surface. A positive connection results in addition in a supported attachment, because here an improved transfer of forces is possible. Such a positive connection between locating surface and counter-locating surface is thus able to assist the accessory attachment means or even to partially form them. Thereby, the positive connection forms so to say a part of the attachment function. In this case, in particular differently oriented surfaces, respectively planes are provided, in order to guarantee thereby the desired or necessary orientation of the accessory module in relation to the rest of the structural components of the roller carriage in a simplified manner. Also a specific arrangement and thereby an automatic selection of exclusive corresponding matching accessory modules may be realized in this way. The safety during mounting with regard to the correct choice of the accessory module can be thereby increased.

It is likewise advantageous, if, in an inventive roller carriage, the at least one accessory device is configured for the attachment of an accessory module according to the present disclosure. In particular, a corresponding first accessory module of at least two different accessory modules is attached to the accessory device. Such a roller carriage, in conjunction with such an accessory module, thereby forms a system, which basically specifies the universal roller carriage with its universal interface in the form of the accessory device. In combination with at least one first accessory module, it is question of the application situation of such a roller carriage.

Another subject matter of the present disclosure is an accessory module for the attachment to an accessory device of a roller carriage, in particular according to the present disclosure. Such an accessory module includes a module body with a counter-locating surface for contacting a locating surface of the accessory device. This arrangement allows for contacting of counter-locating surfaces of at least two different such accessory modules such as to allow for a subsequent attachment by means of at least one accessory attachment means. Such an accessory module thereby forms the complementary component for the system idea of a universal inventive roller carriage. The inventive accessory module thus offers the same advantages as those explained in detail with regard to an inventive roller carriage.

An inventive accessory module may be further developed in that the module body includes at least one functional portion for performing at least one of the following functions:
deflection and/or tensioning function of a drive of the roller carriage,
latching option in a terminal position of the roller carriage,
attachment of a self-closing mechanism,
locking function incorporated into the roller carriage,
position determination of the roller carriage,
attachment of a screen traveling along.

The above enumeration is considered to be a non-exhaustive list. Such accessory modules may be available in an accessory shop or a retrofitting department. Accordingly, such an accessory module can be sold as a stand-alone product. In this case, a deflection or tensioning function is understood to be a rope drive for the roller carriage, which is attached to the roller carriage with corresponding accessory modules. A latching option allows for attaching the roller carriage temporarily in at least one terminal position. A self-closing mechanism allows for providing an automatic closing following an opening procedure for such a roller carriage. In incorporated locking function allows for protecting such a sliding door installation against unwanted opening. Last but not least, a position determination of the roller carriage allows in particular for a detection of the current position situation of the roller carriage, respectively of the closing position of the sliding door itself.

Another subject matter of the present disclosure is a sliding door installation including a roller running path, and at least one inventive roller carriage, which is supported in the roller running path to be displaceable according to the present disclosure. In particular, at least two roller carriages are provided, which support a sliding door to be displaceable in the roller running path. The inventive sliding door installation thus offers the same advantages as those explained in detail with regard to an inventive roller carriage.

Another subject matter of the present disclosure is a method for the attachment of an accessory module, in particular according to the present disclosure, to a roller carriage, in particular according to the present disclosure, including the following steps:
selecting an accessory module among at least two different accessory modules for the attachment to the roller carriage,
contacting a locating surface of an accessory device of the roller carriage with a counter-locating surface of the selected accessory module,
attaching the selected accessory module by means of at least one accessory attachment means of the accessory device.

In this case, the step of selecting can be obviously manually realized at the respective mounting site. Different accessory functions can be employed specifically by means of different accessory modules such that the associated specific accessory module can be selected depending on the desired accessory function. By employing an inventive roller carriage, respectively a corresponding accessory module, such a method offers the same advantages as those explained already in detail in relation to an inventive roller carriage.

### BRIEF DESCRIPTION OF THE DRAWINGS

Further advantages, features and details of the disclosure will result from the following description, in which exemplary embodiments of the disclosure are described in detail, reference being made to the drawings. In the drawings:

FIG. 1 an embodiment of a roller carriage,

FIG. 2 an embodiment of a sliding door installation,

FIG. 3 a lateral illustration of a roller carriage in a roller running path,

FIG. 4 a lateral illustration of a roller carriage in cross-section,

FIG. 5 the illustration of FIG. 4 in an isometric sectional view,

FIG. 6 a frontal view of a roller carriage,

FIG. 7 a selection step prior to mounting an accessory module, and

FIG. 8 the situation according to FIG. 7 after mounting a selected first accessory module.

### DETAILED DESCRIPTION OF THE DRAWINGS

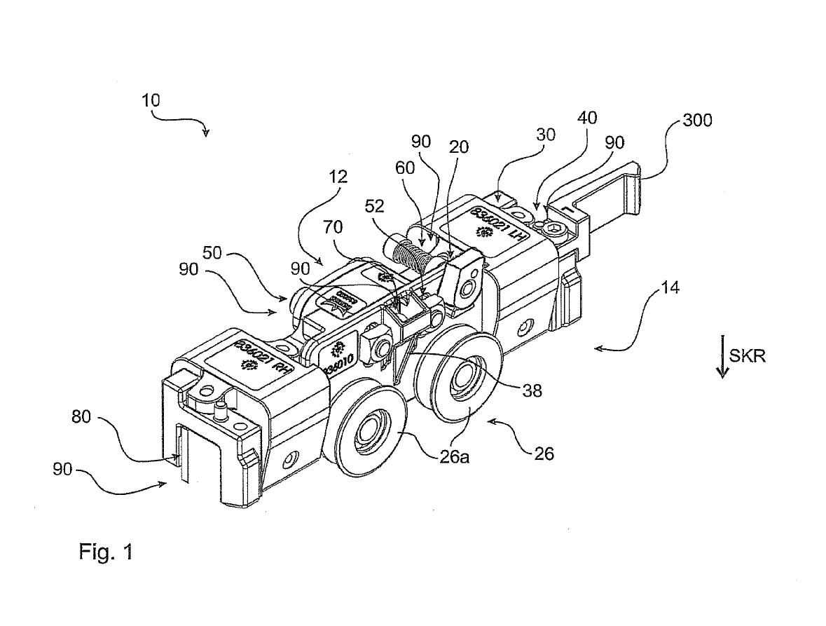

An embodiment of a roller carriage 10 is illustrated in an isometric illustration in FIG. 1. Basically, said carriage includes two structural components. In this case, the components are on the one hand, the roller module 20 and, on the other hand, the basic body 30. In this case, both structural components, namely the roller module 20 and the basic body 30 include a plurality of individual parts. Said individual parts will be briefly explained in the following.

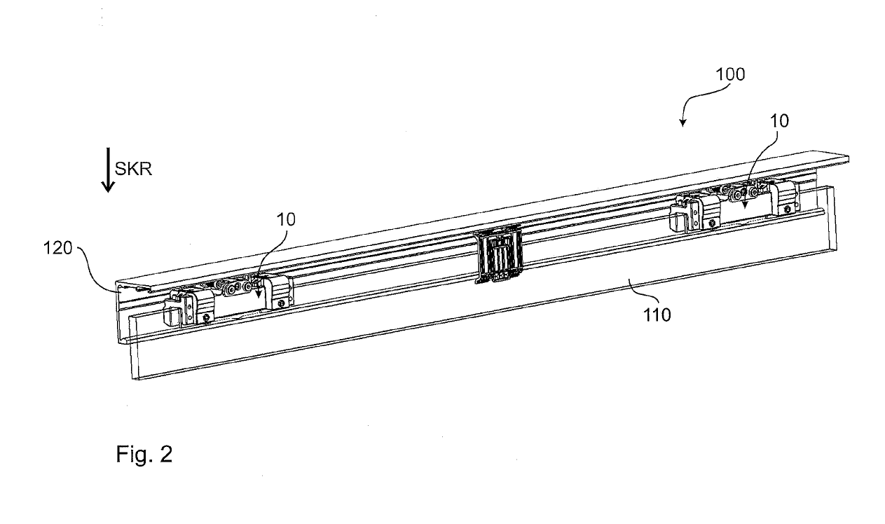

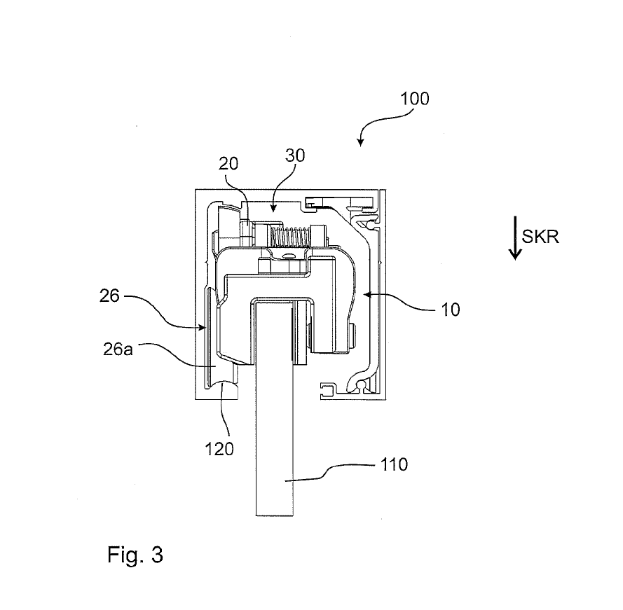

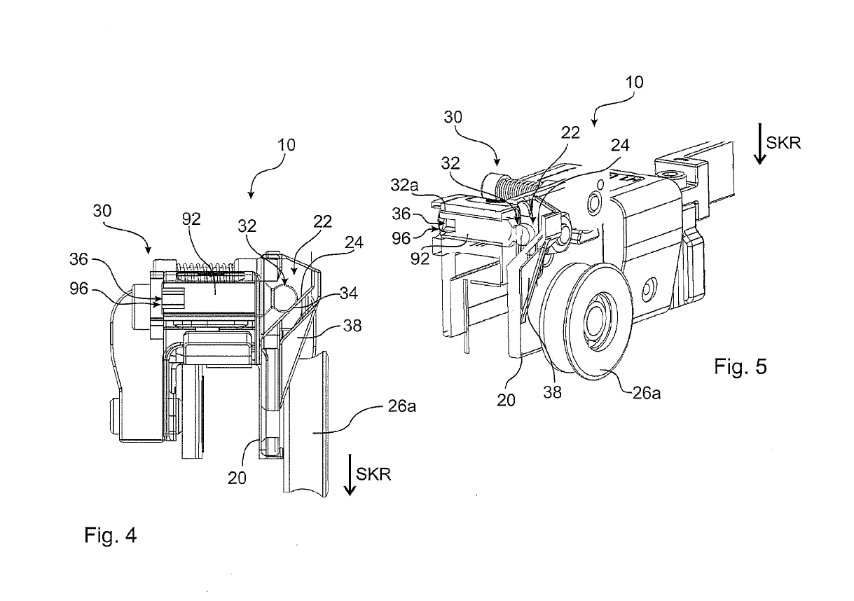

Here, the roller module 20 is equipped with a bearing device 26. Said bearing device 26 is equipped in this case with two rollers 26a, which are supported to be rotatable at a basic body of the roller module 20. Said rollers 26a can be placed onto, respectively inserted into a roller running path 120, as can be clearly seen in FIG. 2 and FIG. 3. A part of a height adjusting device 70 is provided furthermore at the roller module 20. The detailed components of said height adjusting device 70 are in particular illustrated in the FIGS. 4 and 5. Thus, a first adjusting means 32 is provided, which by means of a manipulation interface 36 is able to perform an adjusting movement. As in this case, the first adjusting means 32 is configured as a threaded screw in an adjusting thread 32, a rotary motion is performed at the manipulation interface, which motion simultaneously produces a linear translatory motion of the first adjusting means 32. Via a corresponding contacting portion 34, the first adjusting means 32 is in operative connection with a counter-contacting portion 24 of the second adjusting means 22 of the roller module 20. In this case, the explicit action of said adjusting device relates to transforming the adjusting movement into a fine-tuning movement along the direction of gravity SKR.

As can be seen in FIG. 1, the roller carriage 10 is equipped with a plurality of different mounting devices 90, which are able to provide different mounting functions. In this case, the already described fine-tuning function of the height of the sliding door 110 is provided by means of the mounting device 90 in the shape of the height adjusting device 70. Furthermore, a mounting device 90 in the shape of a securing device 50 is provided, which, after completed fine-tuning of the height of the sliding door 110, provides a clamping fixing between the basic body 30 and the roller module 20.

In this case, a further mounting device 90 includes an accessory device 40, which is provided by means of a corresponding interface and an affixed accessory module 300. Moreover, a lift-off protection device 60 is provided as a mounting device 90, which provides a lift-off protection against unwanted removal of the roller carriage 10 out of the position in which it is inserted into the roller running path 120. Furthermore, an attachment device 80 is provided as a glass clamp for a mounting device 90, in order to affix the sliding door 110 in a clamping manner.

All mounting devices have in common that they include at least one mounting means 92, in order to be able to perform a corresponding mounting movement. Moreover, a manipulation interface is provided, intended to allow for performing exactly said mounting movement with the mounting means.

As furthermore revealed in FIG. 1, the roller carriage 10 has different sides, namely the first side 12 and the second side 14. In this case with regard to their manipulation interface 96, all mounting devices are preferably aligned from the same side, namely the first side 12 opposite to the second side 14, on which the bearing device 26 is disposed. This arrangement offers a considerably simpler access.

FIG. 2 reveals how a sliding door 110 is retained by means of two roller carriages 10 according to FIG. 1, and that the two roller carriages 10 are already inserted into the roller running path 120. In a lateral illustration according to FIG. 3, in particular the correlation of the rollers 26a with the roller running path 120 is well visible.

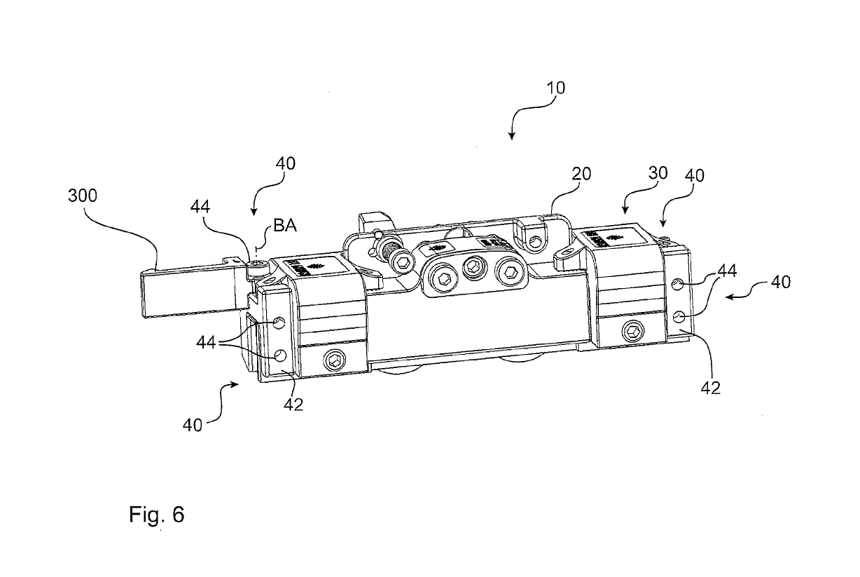

FIG. 6 illustrates the effect of the correlation between basic body 30 and roller module 20 in a frontal view. In this case, altogether three accessory devices 40 are provided, which are configured symmetrically to the center plane of the entire roller carriage 10. A left and a right accessory devices 40 include accessory attachment means 44 in the shape of respectively two holes, which are disposed in the same raster. On both sides, a flat locating surface 42 is likewise provided for each accessory device 40. Also from the top side, respective left and right accessory devices 40 are provided to be symmetrically disposed, wherein an accessory module 300 is already attached to the left end for a corresponding incorporated locking, respectively latching function. Said attachment is realized by means of an accessory attachment means 44 in the shape of a threaded screw, which can be screwed-in in a rotatable manner about an axis of movement BA.

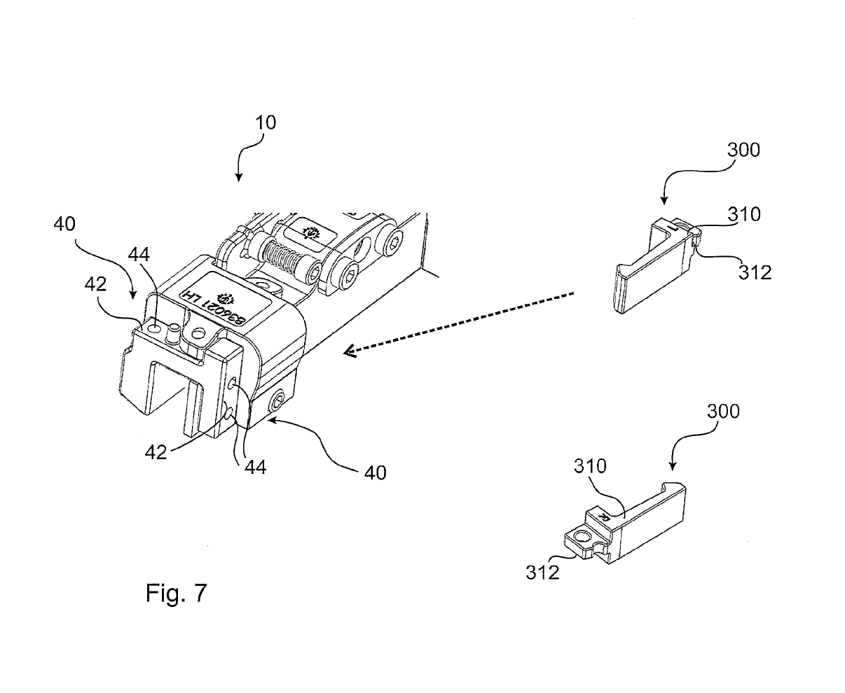

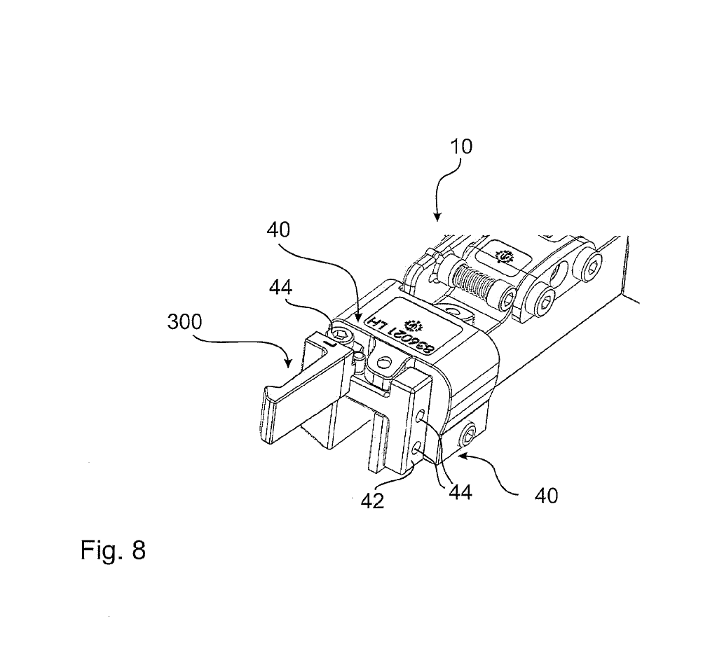

FIGS. 7 and 8 show how an inventive method can be performed. A roller carriage 10 is illustrated in its basic function and with basic equipment. In this case, the left end is shown, at which two different accessory devices 40 are provided. The locating surface 42 as well as the accessory attachment means 44 in the shape of a threaded reception can be likewise seen at the accessory device 40 disposed at the top. FIG. 7, on the right side, reveals a selection of two different accessory modules 300, which are identified with regard to their orientation with R for right and L for left. In this case, the upper accessory module 300 with the identification L is selected for a disposition of the roller carriage 10 on the left side. Subsequently, the mounting to the associated left accessory device 40 is realized with the resulting mounted situation according to FIG. 8. The latter corresponds essentially to the illustration according to FIG. 6.

The above explanation of the embodiments describes the present disclosure exclusively based on examples. Obviously, individual features of the embodiments, as long as technically reasonable, can be combined independently of each other without leaving the scope of the present disclosure.

1. A roller carriage for the reception of a sliding door including a roller module for the displaceable affixing to a roller running path, and a basic body for the attachment to the sliding door, wherein the roller carriage, for the attachment of a first accessory module of at least two different accessory modules, includes at least one accessory device with a locating surface for contacting a counter-locating surface of the first accessory module, and at least one accessory attachment means for the attachment of the first accessory module.

2. The roller carriage according to claim 1, wherein the accessory device is configured as a part of the basic body, and the surface of the basic body includes the locating surface in one section.

3. The roller carriage according to claim 1, wherein the roller carriage includes at least two accessory devices, which are disposed symmetrically or essentially symmetrically with regard to each other.

4. The roller carriage according to claim 1, wherein the roller carriage includes at least two accessory devices, the accessory attachment means thereof being disposed in an identical or essentially identical raster with regard to each other.

5. The roller carriage according to claim 1, wherein the roller carriage includes at least two accessory devices, the accessory attachment means thereof including an identical or essentially identical attachment function.

6. The roller carriage according to claim 1, wherein the accessory attachment means include oblong holes, the extension thereof being configured along a direction of gravity.

7. The roller carriage according to claim 1, wherein the locating surface is configured, at least sectionwise, for a positive connection with the counter-locating surface.

8. The roller carriage according to claim 1, wherein the at least one accessory device is configured for the attachment of an accessory module.

9. The roller carriage according to claim 1, wherein a first accessory module of at least two different accessory modules is attached to the accessory device.

10. An accessory module for the attachment to an accessory device of a roller carriage having the features of claim 1, including a module body with a counter-locating surface for contacting a locating surface of the accessory device, which is configured for contacting of counter-locating surfaces of at least two different accessory modules, and for the attachment by means of at least one accessory attachment means.

11. The accessory module according to claim 10, wherein the module body includes at least one functional portion for performing at least one of the following functions:
deflection and/or tensioning function of a drive of the roller carriage,
latching option in a terminal position of the roller carriage,
attachment of a self-closing mechanism,
locking function incorporated into the roller carriage,
position determination of the roller carriage, and
attachment of a screen traveling along.

12. A sliding door installation, including a roller running path and at least one roller carriage supported to be displaceable in the roller running path having the features of claim 1.

13. The sliding door installation according to claim 12, wherein at least one sliding door is supported to be displaceable in the roller running path by means of at least two roller carriages.

14. A method for the attachment of an accessory module, in particular having the features of claim 10, to a roller carriage, including the following steps:
selecting an accessory module among at least two different accessory modules for the attachment to the roller carriage,
contacting a locating surface of an accessory device of the roller carriage with a counter-locating surface of the selected accessory module, and
attaching the selected accessory module by means of at least one accessory attachment means of the accessory device.
